(19) United States
(12) Patent Application Publication
(10) Pub. No.: US 2021/0206988 A1
(43) Pub. Date: Jul. 8, 2021

(54) CONDUCTIVE INK COMPOSITION

(71) Applicant: HENKEL IP & HOLDING GMBH, Duesseldorf (DE)

(72) Inventors: Yu CHEN, Glastonbury, CT (US); Wenhua Zhang, Farmington, CT (US); Darel Gustafson, Shelton, CT (US); Robert P. Cross, Rocky Hill, CT (US)

(21) Appl. No.: 17/209,342

(22) Filed: Mar. 23, 2021

Related U.S. Application Data
(63) Continuation of application No. PCT/US2019/058773, filed on Oct. 30, 2019.
(60) Provisional application No. 62/752,798, filed on Oct. 30, 2018.

(51) Int. Cl. C09D 11/52; C09D 11/037; C09D 11/033; C09D 11/102; C09D 11/107; C08F 220/18; C08F 226/10; C08F 222/10; C08L 75/04; C08K 3/08; C08K 7/06; C08K 9/02; C08K 3/36; C08K 3/40; C08K 5/14

(52) U.S. Cl. CPC C09D 11/52; C08K 2201/016; C09D 11/033; C09D 11/102; C09D 11/107; C08F 220/1812; C08F 220/1811; C08F 226/10; C08F 222/102; C08F 222/103; C08L 75/04; C08K 3/08; C08K 7/06; C08K 9/02; C08K 3/36; C08K 3/40; C08K 5/14; C08K 2003/0806; C08K 2201/001; C09D 11/037

(57) ABSTRACT

Disclosed herein are electrically conductive ink compositions with high conductivity at a low conductive filler loading, the composition comprising a polymer, a monomer, an initiator or catalyst and conductive filler flakes, optionally the composition can include conductive or non-conductive beads, wherein after cure the monomer and polymer each form a separate phase.

### BACKGROUND OF THE INVENTION

New commercial applications requiring printed conductive materials are continuously arising in the electronics industry. Some of these commercial applications are printed antennas for radio frequency identification (“RFID”) tags, printed transistors and solar cells. Successful introduction of such applications, along with much of the electronics market, are driven by cost and speed of assembly. Consequently, printed conductive materials should be capable of high throughput. High throughput is exemplified by high speed printing techniques such as flexography and rotogravure which are increasingly utilized instead of the slower screen-printing process. For example, production speeds of up to about 400 meters per minute may be achieved through the high-speed printing techniques, as opposed to speeds in the range of about 60 meters per minute via rotary screen printing. As such high-speed techniques are becoming increasingly common in the packaging, consumer and publication industries, conductive materials must be adapted to have the proper rheological properties to be utilized at such high speeds.

Conductive inks are typically designed specifically for inkjet, screen-printing, or roll-to-roll processing methods so that large areas can be processed with fine-scale features in short time periods. Particle-based conductive inks are based on conductive metal particles, which are typically synthesized separately and then incorporated into an ink formulation. The resulting ink is then tuned for a specific printing process.

A conductive ink can selectively be applied to desired substrates by one of these printing processes. A conductive ink generally includes a dispersion of conductive particles and suitable resins in organic solvents. Conducive particles may be constructed of metals, such as copper, nickel, silver or silver-plated copper particles, or carbon.

Conductive inks with high electrical conductivity generally require very high conductive filler loading, for example over 50 vol. %, in cured part. To achieve high conductivity, conductive filler loading needs to be increased so that conductive filler contact is increased encouraging formation of a conductive pathway. However, there is an upper limit to the amount of conductive filler loading that is possible from the amount of resin required to bind the material into an ink and due to the upper limit on viscosity of the ink to permit dispensing onto the desired substrate. Therefore, there remains a need for electronically conductive ink that exhibits high conductivity at low conductive filler loading.

### SUMMARY OF THE INVENTION

Disclosed herein is a conductive ink composition comprising: a polymer, a monomer, an initiator or a catalyst, and conductive filler flakes, wherein after the monomer cures the monomer and polymer each form a separate phase and the composition has a resistivity of less than or equal to about 10 Ohm/sq/25 μm when the conductive filler flakes are present in the composition in an amount of about 10 vol. % to about 50 vol. %.

In an alternative embodiment, disclosed herein is a conductive ink composition ink composition comprising: a polymer, beads having an aspect ratio in the range of about 0.9 to about 1.1, conductive filler flakes, wherein the conductive filler flakes are present in the composition in an amount of about 10 vol. % to about 50 vol. %, and wherein the resistivity is less than or equal to about 10 Ohm/sq/25 μm.

In another alternative embodiment, disclosed herein is a conductive ink composition comprising: a polymer, a monomer, beads having an aspect ratio in the range of about 0.9 to about 1.1, non-spherical conductive filler flakes, and an initiator or a catalyst, wherein after cure the monomer and polymer each form a separate phase. The conductive filler flakes are present in the composition in an amount of about 10 vol. % to about 50 vol. %, and the resistivity is less than or equal to about 10 Ohm/sq/25 μm.

### BRIEF DESCRIPTION OF THE DRAWINGS

FIG. 1 depicts resistance versus percentage of conductive filler when using different sized beads in an ink composition;

FIG. 2 depicts resistance versus percentage of filler for a non-phase separated system compared to a phase separated system including beads.

### DETAILED DESCRIPTION OF THE INVENTION

Disclosed herein is an inventive electronically conductive ink composition comprising: a polymer, a monomer, an initiator or a catalyst, and conductive filler flakes.

After cure, the monomer and polymer each form a separate phase. The inventive electronically conductive ink composition has a resistivity of less than or equal to about 10 Ohm/sq/25 μm when conductive filler flakes are present in the composition in an amount of about 10 vol. % to about 50 vol. %.

The inventive electronically conductive ink compositions have decreased resistivity with low conductive filler loading because of in-situ polymerization induced phase-separation from the inclusion of a monomer and a polymer and/or by silver flake orientation control from this in-situ polymerization and/or the addition of beads to the composition. The composition phase separates when the monomer cures. Before curing, the monomer and polymer solution is a single phase.

The conductive ink composition disclosed herein includes a polymer and a monomer. The monomer and polymer used in the composition should be selected such that the monomer and polymer are able to form two separate phases after cure.

For example, useful monomers can include epoxy monomers, acrylic monomers, and (meth)acrylate. Specific examples of suitable monomers include methyl methacrylate, methyl acrylate, butyl methacrylate, t-butyl methacrylate, 2-ethylhexyacrylate, 2-ethylhexylmethacrylate, ethyl acrylate, isobornyl methacrylate, isobornyl acrylate, 2-hydroxyethyl methacrylate, glycidyl methacrylate, tetrahydrofurfuryl methacrylate, acrylamide, n-methyl acrylamide. Further examples include acrylate or methacrylate containing monomers which are mono- or poly-functionalized and which apart from hydroxyl groups contain amide-, cyano-, chloro- and silane substituents.

Particularly useful monomers that can be included in the composition of the present invention include (meth)acrylate monomers. The type of (meth)acrylate monomer that is used in the composition can be changed based on the desired cure properties. For example, for a faster UV or thermal cure an acrylate monomer can be used. Preferably, the acrylate monomer is selected from the group comprising trimethylolpropane triacrylate, 1-vinyl-2-pyrrolidinone, lauryl acrylate, 1,6-hexanediol diacrylate, or a combination thereof, the structures of which are reproduced below.

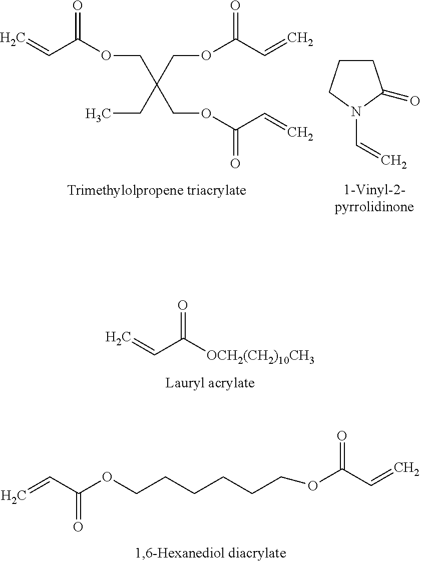

Preferably the monomer has a rigid fused ring structure such as isobornyl acrylate, Tricyclo [5,2,1,0] decanedimethanol diacrylate (Trade name SR833S) and dicyclopentanyl acrylate, shown below.

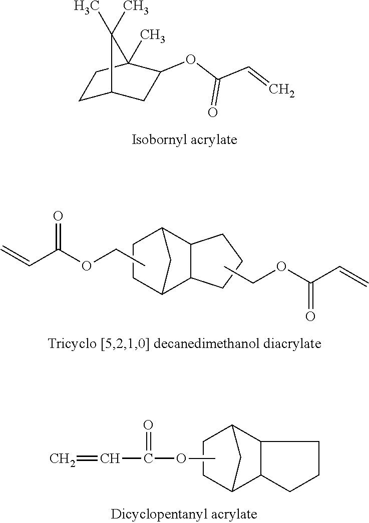

Useful polymers should form a separate phase from the monomer included in the composition when cured. For example, polymers that can be used in the composition disclosed herein include but are not limited to thermoplastic polymers, thermosetting polymers and elastomers.

Specifically, the thermoplastic polymers include but are not limited to: polyacrylate, ABS, Nylon, PLA, polybenzimidazole, polycarbonate, polyether sulfone, polyoxymethylene, polyetherether ketone, polyetherimide, polyethylene, polyphenylene oxide, polyphenylene sulfide, polypropylene, polystyrene, polyvinyl chloride, and Teflon.

Thermosetting polymers that can be used in the composition include but are not limited to: polyester, polyurethanes, polyurea/polyurethane, vulcanized rubber, bakelite, phenol-formaldehyde, duroplast, urea-formaldehyde, melamine, diallyl-phthalate (DAP), epoxy, epoxy novolac, benzoxazines, polyimides, bismaleimides, cyanate esters, polycyanurates, furan, silicone, thiolyte, and vinyl ester.

Elastomers that can be used in the composition include but are not limited to: usaturated rubbers, such as: polyisoprene, polybuadiene, chloroprene, polychloroprene, neoprene, baypren, butyl rubber, halogenated butyl rubbers, styrene-butadiene, hydrogenated nitrile, therban, zetpol; saturated rubbers, such as: ethylene propylene (EPM), ethylene propylene diene (EPDM, epichlorohydrin (ECO), polyacrlic rubber (ACM, ABR), silicone rubber, flurorosilicone rubber, fluroroelastomers viton, tecnoflon, fluorel, aflas, Dai-El, perfluoroelastomers, tecnoflon PFR, Kalrez, Chemaz, Perlast, Polyether block amides (PEBA), chlorosulfonated polyethlene (CSM), Hypalon, ethylene-vinyl acetated (EVA); Other 4S elastomers, such as: thermoplasitic elastomers (TPE), the proteins resilin and elastin, polysulfide rubber, elastolefin, and elastic fiber.

The volume ratio of polymer to monomer included in the composition can be optimized based on the desired amount of conductive filler and the desired resistivity of the composition. In a particularly useful embodiment, the volume ratio of polymer to monomer can be in the range of about 0.05 to about 0.95, specifically about 0.3 to about 0.7, more specifically about 0.4 to about 0.6.

The composition disclosed herein further includes conductive fillers. The conductive filler's distribution can be controlled using the phase separated system such that the filler is distributed on the interface of the two phases or in one of the phases. As described throughout this phase separated system is created by curing the composition, which causes the monomer and polymer to form separate phases.

One or more conductive fillers are included in the composition. Exemplary conductive fillers include, but are not limited to, silver, copper, gold, palladium, platinum, nickel, gold or silver-coated nickel, carbon black, carbon fiber, graphite, aluminum, indium tin oxide, silver coated copper, silver coated aluminum, metallic coated glass spheres, metallic coated filler, metallic coated polymers, silver coated fiber, silver coated spheres, antimony doped tin oxide, conductive nanospheres, nano silver, nano aluminum, nano copper, nano nickel, carbon nanotubes and mixtures thereof. In one embodiment the conductive filler is a mixture of different size silver flakes, such as a mixture of SF-80, commercially available from Ferro, and SF-AA0101, commercially available from Metalor.

The conductive filler flakes can be in the geometric form of flake, dendritic, or needle type filler flakes. Specifically, the conductive filler flakes can have an aspect ratio outside the range of about 0.9 to 1.1, preferably greater than about 1.1.

Due to the composition including either a phase separated polymer and monomer system, or beads, or both, less conductive filler flakes are required to obtain desired resistivities. For example, in an exemplary embodiment, the conductive filler flakes present in the composition in an amount of about 10 vol. % to about 50 vol. % based on the total volume of the composition.

The resulting composition including the phase separated monomer and polymer will have a resistivity of less than a composition without phase separation comprising the same amount of conductive filler flakes. In a particularly useful embodiment, the resistivity of the cured composition is less than or equal to 10 Ohm/sq/25 μm, for example less than or equal to 0.007 Ohm/sq/25 μm, when the conductive filler flakes are present in the composition in an amount of about 10 vol. % to about 50 vol. % based on the total volume of the composition.

The composition can further include an initiator. Specifically, useful initiators can be selected from a variety of initiators depending on the desired cure mechanism of the composition. For example, the initiator can be a thermal initiator or a UV initiator. The thermal initiator or UV initiator should be chosen such that when included in the composition heat cure or light cure, respectively, is possible.

The composition can further comprise additional optional components. For example, the composition can further comprise a solvent.

In an alternative embodiment, the inventive electrically conductive ink composition can comprise a polymer, beads having an aspect ratio in the range of about 0.9 to about 1.1, and conductive filler flakes.

In a further alternative embodiment, beads having an aspect ratio in the range of about 0.9 to about 1.1 can be included in the conductive silver ink composition described above including a phase separated polymer and monomer.

When the randomness of the orientation of the conductive fillers is increased, the contact efficiency of the conductive fillers is improved. Combining non-spherical conductive fillers with an aspect ratio outside of about 0.9 to about 1.1 with low aspect ratio spherical beads (aspect ratio of about 0.9 to about 1.1) can help increase this randomness of the orientation of the conductive fillers, thereby increasing the contact efficiency of the conductive fillers. The size ratio of the beads to the flake must be optimized in order to increase the randomness of the filler orientation.

The beads can be either non-conductive or conductive. For example, the beads can be made of silica, glass, clay, or polymers. The beads can also be made of silver, copper, gold, palladium, platinum, nickel, gold or silver-coated nickel, carbon black, carbon fiber, graphite, aluminum, indium tin oxide, silver coated copper, silver coated aluminum, metallic coated glass spheres, metallic coated filler, metallic coated polymers, silver coated fiber, silver coated spheres, antimony doped tin oxide, conductive nanospheres, nano silver, nano aluminum, nano copper, nano nickel.

The volume ratio of the beads to conductive filler flakes can be in the range of about 0 to about 0.5, for example in the range of 0.005 to 0.16. The size ratio size ratio of the diameter of the beads to the size of the flake can be in the range of about 0.5 to about 2.0, for example about 0.85 to about 1.15.

The beads can be included in a conductive ink composition to decrease resistivity with lower filler loading with or without phase separation, as demonstrated in the examples described below.

### Examples

Ink Composition Preparation

A conductive ink including silver flake and resin was created. First, thermoplastic polyurethane (TPU) resin was dissolved in a solvent system. 7 μm Silver flake was then added to the mixture under 100% vacuum speed mix for 4 minutes at 900 rpm. The mixture was then speed mixed for 1 minute 30 seconds at 2200 rpm to form an ink composition.

A conductive ink including silver flake, resin, and beads was created. First, thermoplastic polyurethane (TPU) resin was dissolved in a solvent system. 7 μm Silver flake was then added to the mixture under 100% vacuum speed mix for 4 minutes at 900 rpm. Then spherical silica beads were added to the mixture and the mixture was speed mixed for 1 minute 30 seconds at 2200 rpm to form an ink composition.

### Example 1: Comparison of Ink with Silicon Beads

Two ink compositions were prepared according to the methods above. Formula A does not include beads, while Formula B includes 7 μm silica beads.

The ink compositions were then printed on glass slides in a pattern using screen printing. The printed glass slides were dried in the oven at 120° C. for 30 min then removed from the oven and cooled to room temperature. The width of the printed ink was measured by HiRox RH-8800 digital microscope. The thickness of the printed ink was measured by laser thickness measurement system. The resistance of the sample was measured by 4 probe Ohm meter.

A high aspect ratio conductive flake and low aspect ratio beads provide high conductivity with lower conductive flake loading. Table 1 shows the change in resistance as a function of a change in volume percent of filler included in the composition. Table 1 indicates that the inclusion of silica beads significantly lowered the resistance of the ink composition (Rp Ohm/sq/mil).

TABLE 1

| Formula/Ag vol % | 21.05% | 25.53% | 31.37% | 34.24% |
|---|---|---|---|---|
| A | 9.691377 | 1.640326 | 0.250021 | 0.114276 |
| B | 0.201751 | 0.116046 | 0.076383 | 0.065288 |

### Example 2: Impact of Relationship of Bead Size to Flake Size

The ratio of flake/beads are important in reducing the resistivity of the overall composition. The compositions were created according to the method outlined above. The composition with Ag flake was created with 7 μm Ag flake and no beads. The remaining compositions were created with beads of varying sizes as described in the tables below at a resin:bead ratio of about 1:1.

TABLE 2

| Material | Size (micron) | Beads/Ag flake size ratio |
|---|---|---|
| Ag flake | 7 | 1 |
| 3 μm Silica Bead | 3 | 0.43 |
| 5 μm Silica Bead | 4 | 0.57 |
| 7 μm Silica Bead | 6 | 0.86 |

TABLE 3

| Ag vol % | 20.00% | 25.00% | 30.00% | 35.00% | 40.00% | 45.00% | 50.00% |
|---|---|---|---|---|---|---|---|
| 3 μm Silica | 0.256159 | 0.176535 | 0.14987386 | 0.119561 | 0.089984 | 0.088802 | 0.099423 |
| Bead | | | | | | | |
| 5 μm Silica | 0.316742 | 0.177477 | 0.16242836 | 0.130116 | 0.108769 | 0.084195 | 0.082949 |
| Bead | | | | | | | |
| 7 μm Silica | 0.201751 | 0.116046 | 0.07638321 | 0.065288 | 0.058381 | 0.051156 | 0.05699 |
| Bead | | | | | | | |

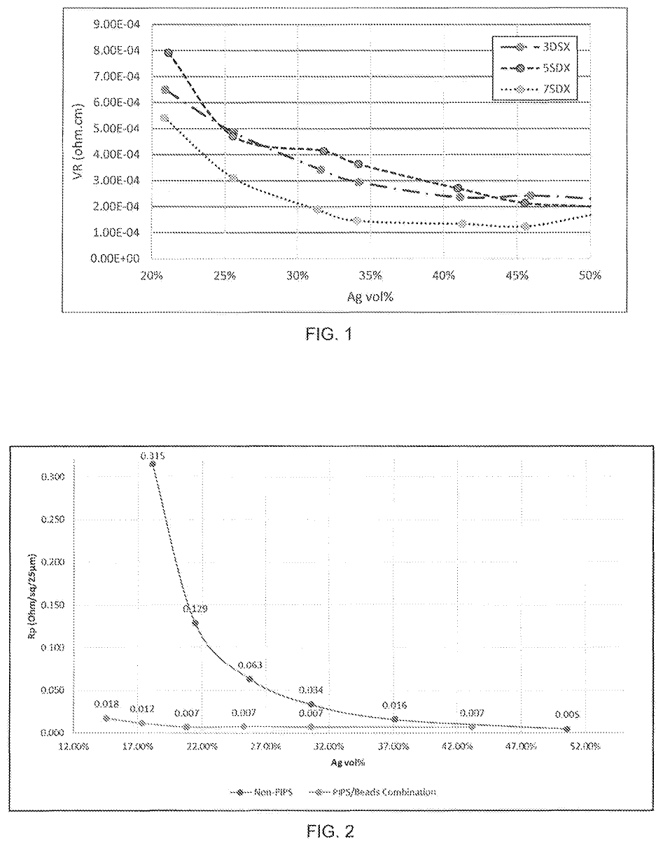

The data obtained in Tables 2 and 3 demonstrates that when the ratio of resin to beads is close to about 1.0 the best result is obtained. This data is shown in FIG. 1.

### Example 3: Comparison of Beads with Different Physical Properties

The physical properties of the beads included in the composition, such as shape, material and surface treatment impact the resistivity of the ink composition, as shown in Table 4 below. Formulations C-F in Table 4 were created in accordance with the method described above using different types of beads as shown in Table 4. The resistivity was calculated for each composition.

TABLE 4

| Formulation | C | D | E | F |
|---|---|---|---|---|
| Beads | Ag coated | Ag coated | Silica | No beads |
| | glass spherical | glass flake | spherical | |
| Rp | 0.0245 | 0.0343 | 0.0283 | 0.0423 |
| (Ohm/sq/25 μm) | | | | |

The results set forth in Table 4 demonstrate that low aspect ratio beads give higher conductivity, conductive material coated beads give higher conductivity and when you compare these two factors, the shape of the beads is more important that low aspect ratio beads to provide lower resistivity.

### Example 4: Optimization of Bead/Silver Ratio

The relationship of amount of beads versus silver flake and the effect on resistivity was tested. Different ink compositions were created according to the method described above and the resistivity was tested. 7 μm silver flake was included in the ink compositions. The amount of spherical silica beads with 1:1 size ratio to silver flakes in each ink composition was varied to determine the optimal ratio of beads to silver flake for the lowest resistivity. The results are shown in Table 5 below.

TABLE 5

| | G | H | I | J | K | L | M | F |
|---|---|---|---|---|---|---|---|---|
| Beads/non-Ag | 70% | 60% | 50% | 40% | 30% | 20% | 10% | 0% |
| resin vol % | | | | | | | | |
| Beads/Ag vol % | 99.7% | 85.45% | 71.21% | 56.97% | 42.73% | 28.48% | 14.24% | 0% |
| Rp | 0.1121 | 0.0908 | 0.0777 | 0.049 | 0.0348 | 0.0269 | 0.0270 | 0.0361 |
| (Ohm/sq/25 μm) | | | | | | | | |

### Example 5: Comparison of Phase Separation with Non-Phase Separation Inks

A phase separated ink system was formed as follows. First, TPU resin was dissolved in a solvent system. The system was then speed mixed for 1 minute 30 seconds at 2200 rpm. Next, 5 μm silver flake was added to the mixture under 100% vacuum speed mix for 4 minutes at 900 rpm. Next, a monomer Isobomyl acrylate [IBOA]/catalyst benzoyl peroxide [BPO] solution was added to the mixture with a rheology additive. The mixture was then speed mixed for 1 minute 30 seconds at 2200 rpm.

A non-phase separated ink system was formed as follows. TPU resin was dissolved in a solvent system. The system was then speed mixed for 1 minute 30 seconds at 2200 rpm. Next, 5 μm silver flake was added to the mixture under 100% vacuum speed mix for 4 minutes at 900 rpm.

Each ink system was then screen printed onto a substrate. After the ink was printed, it was left in the oven under a temperature for ample time to allow the solvent to evaporate and the monomer to cure. Typically the time and temperature conditions are 120° C. for 30 minutes, 120° C. for 15 minutes, 90° C. for 15 minutes, 150° C. for 2 minutes, etc. The resistivity was then tested for each ink composition and the results are reproduced in Table 6.

TABLE 6

| Ag vol % | | 20% | 30% | 35% | 42% |
|---|---|---|---|---|---|
| Resistivity | Non-Phase | 9.691 | 0.25 | 0.114 | 0.037 |
| (Ohm/sq/ | separated | | | | |
| 25 μm) | system | | | | |
| | Phase | 0.0354 | 0.0626 | 0.0234 | 0.0139 |
| | separated | | | | |
| | system | | | | |

The results obtained in Table 7 indicate that the phase separated system leads to higher conductivity with lower conductive filler loading even when beads are not included in the system.

### Example 6: Combination of Beads and Phase Separated Polymers in an Ink Composition

First, TPU resin was dissolved in a solvent system, and then spherical silica beads with 1:1 size ratio to the 5 μm silver flakes were added. The amount of beads can be varied and it was determined separately that for the best result (the lowest resistivity) the beads/Ag vol ratio should be about 7%. Accordingly, beads were added at a volume ratio of about 7% with the silver flake. The system was then speed mixed for 1 minute 30 seconds at 2200 rpm. Next, 5 μm silver flake was added to the mixture under 100% vacuum speed mix for 4 minutes at 900 rpm. Next, a monomer [IBOA]/catalyst [BPO] solution was added to the mixture with a rheology additive. The mixture was then speed mixed for 1 minute 30 seconds at 2200 rpm. The amount of silver flake included in the composition was adjusted to try to obtain 0.007 Ohm/sq/25 μm resistivity.

The results shown in Table 7, reproduced below. Table 7 demonstrates that the phase separation increases conductivity and lowers the resistivity of the composition. These results further demonstrate that the composition including phase separation reduces the amount of silver flake required to obtain a desired conductivity and a phase separated system with beads reduces the amount of silver flake required to obtain a desired conductivity even further. These results are depicted in FIG. 2.

TABLE 7

| Ag vol % | 18.10% | 21.46% | 25.77% | 30.58% | 37.13% | 50.60% |
|---|---|---|---|---|---|---|
| Non-PIPS/Beads Formulation | 0.3151 | 0.1290 | 0.0633 | 0.0337 | 0.0159 | 0.0048 |
| [Rp(Ohm/sq/25 μm)] | | | | | | |
| PIPS/Beads formulation | 0.018 | 0.012 | 0.007 | 0.007 | 0.006 | 0.006 |
| [Rp(Ohm/sq/25 μm)] | | | | | | |

What is claimed is:

1. A conductive ink composition comprising:
a polymer,
a monomer,
an initiator or a catalyst,
conductive filler flakes,
wherein after cure the monomer and polymer each form a separate phase,
wherein the conductive filler flakes are present in the composition in an amount of about 10 vol. % to about 50 vol. %, and
wherein the composition has a resistivity of less than or equal to about 10 Ohm/sq/25 μm.

2. The conductive ink composition of claim 1, wherein the resistivity is less than or equal to about 0.007 Ohm/sq/25 μm.

3. The conductive ink composition of claim 1, wherein the conductive filler flakes are present in the composition in an amount of about 10 vol. % to about 15 vol. %.

4. The conductive ink composition of claim 1, wherein the volume ratio of polymer to monomer in the composition is in the range of about 0.05 to about 0.95.

5. The conductive ink composition of claim 1, wherein the volume ratio of polymer to monomer in the composition is in the range of about 0.3 to about 0.7.

6. The conductive ink composition of claim 1, wherein the composition further comprises a solvent.

7. The conductive ink composition of claim 1, wherein the conductive filler flakes comprise silver, nickel, copper, fillers coated with silver, nickel or copper, or a combination thereof.

8. The conductive ink composition of claim 1, wherein the conductive filler flakes comprise silver.

9. The conductive ink composition of claim 1, wherein the composition comprises an initiator that is a thermal initiator.

10. The conductive ink composition of claim 1, wherein the composition comprises an initiator that is a UV initiator.

11. The conductive ink composition of claim 1, wherein the conductive filler flakes are flake, dendritic, or needle type filler flakes.

12. A conductive ink composition comprising:
a polymer,
beads having an aspect ratio in the range of about 0.9 to about 1.1, conductive filler flakes,
wherein the conductive filler flakes are present in the composition in an amount of about 10 vol. % to about 50 vol. %, and
wherein the resistivity is less than or equal to about 10 Ohm/sq/25 μm.

13. The conductive ink composition of claim 12, wherein the resistivity is less than or equal to about 0.007 Ohm/sq/25 μm.

14. The conductive ink composition of claim 12, wherein the conductive filler flakes are present in the composition in an amount of about 10 vol. % to about 15 vol. %.

15. The conductive ink composition of claim 12, wherein the conductive filler flakes are flake, dendritic, or needle type filler flakes.

16. The conductive ink composition of claim 12, wherein the beads are non-conductive.

17. The conductive ink composition of claim 12, wherein the beads are conductive.

18. The conductive ink composition of claim 12, wherein the beads are made of silica, glass, clay, or polymers.

19. The conductive ink composition of claim 12, wherein the conductive filler flakes comprise silver, nickel, or copper or fillers coated with silver, nickel or copper.

20. The conductive ink composition of claim 12, wherein the conductive filler flakes comprise silver.

21. The conductive ink composition of claim 12, wherein the volume ratio of the beads to conductive filler flakes is in the range of about 0 to about 0.5.

22. The conductive ink composition of claim 12, wherein the volume ratio of the beads to conductive filler flakes is in the range of about 0.005 to about 0.16.

23. The conductive ink composition of claim 12, wherein the size ratio of the beads to the conductive filler flakes is in the range of about 0.5 to about 2.0.

24. The conductive ink composition of claim 12, wherein the size ratio of the beads to the conductive filler flakes is in the range of about 0.85 to about 1.15.

25. A conductive ink composition comprising:
a polymer,
a monomer,
beads having an aspect ratio in the range of about 0.9 to about 1.1, conductive filler flakes,
an initiator or a catalyst,
wherein after cure the monomer and polymer each form a separate phase,
wherein the conductive filler flakes are present in the composition in an amount of about 10 vol. % or greater, and
wherein the resistivity is less than or equal to about 10 Ohm/sq/25 μm.
